(19) United States
(12) Patent Application Publication
(10) Pub. No.: US 2020/0040814 A1
(43) Pub. Date: Feb. 6, 2020

(54) ACTUATOR OF VARIABLE COMPRESSION RATIO MECHANISM FOR INTERNAL COMBUSION ENGINE AND VARIABLE COMPRESSION RATIO APPARATUS FOR INTERNAL COMBUSTION ENGINE

(71) Applicant: HITACHI AUTOMOTIVE SYSTEMS, LTD., Hitachinaka-shi, Ibaraki (JP)

(72) Inventors: Kishiro NAGAI, Atsugi-shi, Kanagawa (JP); Yoshihiro SUDA, Ebina-shi, Kanagawa (JP)

(73) Assignee: HITACHI AUTOMOTIVE SYSTEMS, LTD., Hitachinaka-shi, Ibaraki (JP)

(21) Appl. No.: 16/492,397

(22) PCT Filed: Mar. 8, 2018
(86) PCT No.: PCT/JP2018/008895

§ 371 Date: Sep. 9, 2019

(30) Foreign Application Priority Data
Mar. 16, 2017 (JP) 2017-050716

(51) Int. Cl. F02B 75/04; F01M 11/02; F01M 1/06; F02D 15/02; F16C 17/02; F16C 33/10

(52) U.S. Cl. CPC F02B 75/045; F01M 11/02; F01M 1/06; F01M 1/02; F16C 17/02; F16C 33/106; F01M 2011/027; F02D 15/02

(57) ABSTRACT

An actuator of a variable compression ratio mechanism for an internal combustion engine includes an arm link 13 configured to change a posture of the variable compression ratio mechanism for the internal combustion engine by swinging, a second control shaft 11 fixed to the arm link 13, and a housing 20 including a first bearing hole 301a supporting the second control shaft 11. The housing 20 includes a lubricant oil supply oil passage 202 opened to a pressure-receiving range over which a contact pressure is received at the first bearing hole 301a from the second control shaft 11 during an expansion stroke of the internal combustion engine.

### TECHNICAL FIELD

The present invention relates to an actuator of a variable compression ratio mechanism for an internal combustion engine and a variable compression ratio apparatus for an internal combustion engine.

### BACKGROUND ART

PTL 1 discloses an actuator including an arm link that changes a posture of a variable compression ratio mechanism for an internal combustion engine, a control shaft fixed to the arm link, and a housing including a bearing portion supporting the control shaft.

### CITATION LIST

### Patent Literature

[PTL 1] Japanese Patent Application Public Disclosure No. 2016-138467

### SUMMARY OF INVENTION

### Technical Problem

When the internal combustion engine is subjected to a high load, the bearing portion receives a locally high contact pressure from the control shaft due to a load derived from an explosion force in the internal combustion engine that is input from the variable compression ratio mechanism to the control shaft. Therefore, this configuration may be prone to insufficiency of lubricant oil at this portion and facilitate friction between the control shaft and the bearing portion, thereby leading to a reduction in durability.

One of objects of the present invention is to provide an actuator of a variable compression ratio mechanism for an internal combustion and a variable compression ratio apparatus for an internal combustion engine capable of preventing or reducing the friction between the control shaft and the bearing portion.

### Solution to Problem

According to one embodiment of the present invention, an actuator of a variable compression ratio mechanism for an internal combustion engine includes a housing having an oil passage opened to a pressure-receiving range over which a contact pressure is received at a bearing portion from a control shaft during an expansion stroke of the internal combustion engine.

Therefore, according to the one embodiment of the present invention, the friction can be prevented or reduced between the control shaft and the bearing portion.

### BRIEF DESCRIPTION OF DRAWINGS

FIG. 1 schematically illustrates an internal combustion engine including a variable compression ratio apparatus for the internal combustion engine according to a first embodiment.

FIG. 2 is an exploded perspective view of an actuator of a variable compression ratio mechanism for the internal combustion engine according to the first embodiment.

FIG. 3 is a perspective view of the actuator of the variable compression ratio mechanism for the internal combustion engine according to the first embodiment.

FIG. 4 is a plan view of the actuator of the variable compression ratio mechanism for the internal combustion engine according to the first embodiment.

FIG. 5 is a cross-sectional view taken along a line indicated by arrows S1 and S1 illustrated in FIG. 4.

FIG. 6 is a cross-sectional view taken along a line indicated by arrows S2 and S2 illustrated in FIG. 5.

FIG. 7 is an exploded perspective view of a strain wave gearing speed reducer according to the first embodiment.

FIG. 8 is a cross-sectional view taken along a line indicated by arrows S3 and S3 illustrated in FIG. 5.

FIG. 9 is a cross-sectional view taken along a line indicated by arrows S4 and S4 illustrated in FIG. 5.

FIG. 10 schematically illustrates the actuator with a second control shaft 11 and a metallic bush 301 in surface contact with each other.

FIG. 11 is a cross-sectional view taken along the line indicated by the arrows S3 and S3 illustrated in FIG. 5 according to a second embodiment.

FIG. 12 is a cross-sectional view taken along the line indicated by the arrows S4 and S4 illustrated in FIG. 5 according to the second embodiment.

FIG. 13 is a cross-sectional view taken along the line indicated by the arrows S3 and S3 illustrated in FIG. 5 according to a third embodiment.

FIG. 14 is an enlarged view of main portions in cross section taken along the line indicated by the arrows S3 and S3 illustrated in FIG. 5 according to a fourth embodiment.

FIG. 15 is an enlarged view of main portions in cross section taken along the line indicated by the arrows S3 and S3 illustrated in FIG. 5 according to a fifth embodiment.

### DESCRIPTION OF EMBODIMENTS

### First Embodiment

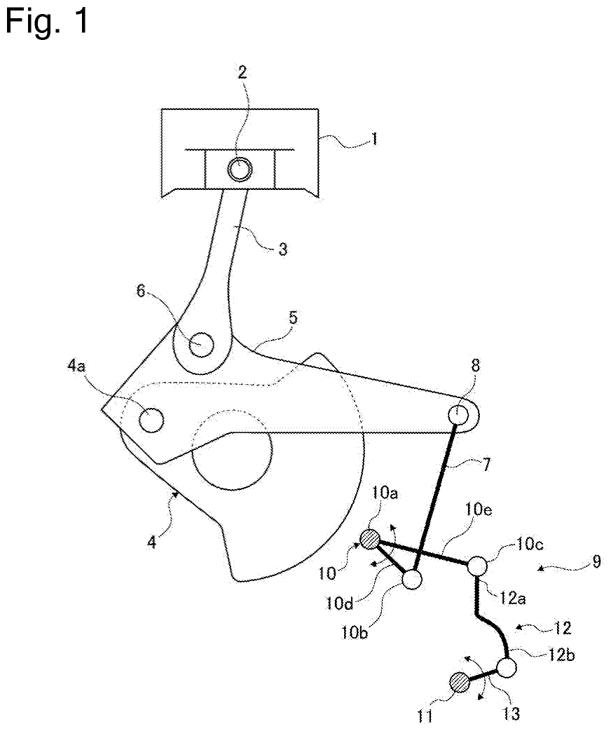

FIG. 1 schematically illustrates an internal combustion engine including a variable compression ratio apparatus for the internal combustion engine according to a first embodiment. This internal combustion engine has a basic configuration similar to the configuration illustrated in FIG. 1 of Japanese Patent Application Public Disclosure No. 2011-169251, and therefore will be described briefly.

A piston 1 reciprocates in a cylinder of a cylinder block in the internal combustion engine (a gasoline engine). An upper end of an upper link 3 is rotatably coupled with the piston 1 via a piston pin 2. A lower link 5 is rotatably coupled with a lower end of the upper link 3 via a coupling pin 6. A crankshaft 4 is rotatably coupled with the lower link 5 via a crank pin 4a. An upper end portion of a first control link 7 is rotatably coupled with the lower link 5 via a coupling pin 8. A lower end portion of the first control link 7 is coupled with a coupling mechanism 9 including a plurality of links. The coupling mechanism 9 includes a first control shaft 10, a second control shaft 11, a second control link 12, and an arm link 13.

The first control shaft 10 is disposed in parallel with the crankshaft 4 disposed along a direction of a cylinder bank inside the internal combustion engine. The first control shaft (a first shaft portion) 10 includes a first journal portion 10a, a control eccentric shaft portion 10b, an eccentric shaft portion 10c, a first arm portion 10d, and a second arm portion 10e. The first journal portion 10a is rotatably supported on a main body of the internal combustion engine. The control eccentric shaft portion 10b is rotatably coupled with the lower end portion of the first control link 7. The eccentric shaft portion 10c is rotatably coupled with one end portion 12a of the second control link (a first link) 12. One end of the first arm portion 10d is coupled with the first journal portion 10a. The other end of the first arm portion 10d is coupled with the control eccentric shaft portion 10b. The control eccentric shaft portion 10b is located at a position eccentric with respect to the first journal portion 10a by a predetermined amount. One end of the second arm portion 10e is coupled with the first journal portion 10a. The other end of the second arm portion 10e is coupled with the eccentric shaft portion 10c. The eccentric shaft portion 10c is located at a position eccentric with respect to the first journal portion 10a by a predetermined amount. One end of the arm link 13 is rotatably coupled with the other end portion 12b of the second control link 12. The other end of the arm link 13 is coupled with the second control shaft 11. The arm link 13 and the second control shaft 11 are not movable relative to each other. The second control shaft 11 is rotatably supported in a housing 20, which will be described below.

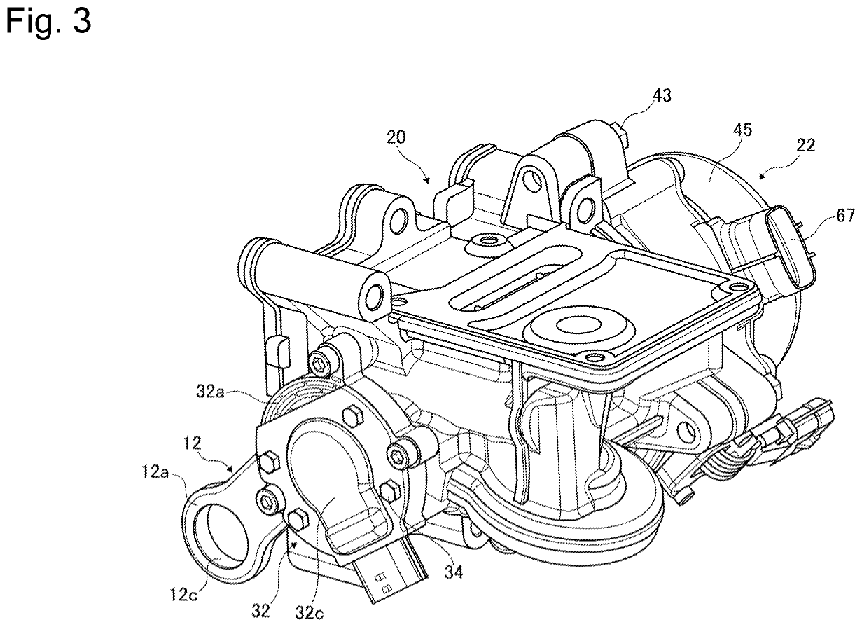

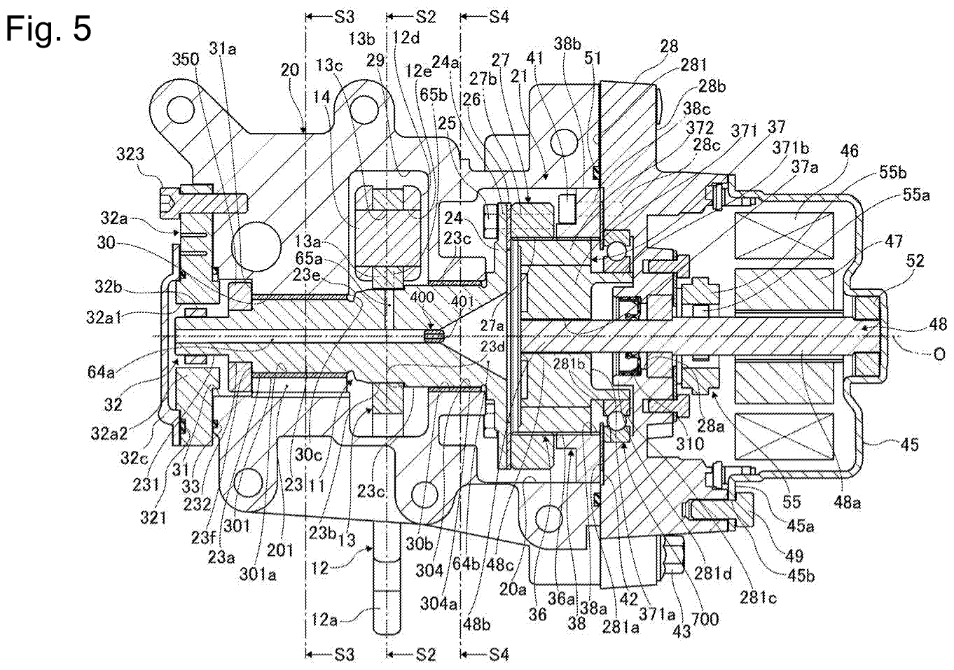

The second control link 12 is prepared in the form of a lever, and the one end portion 12a thereof coupled with the eccentric shaft portion 10c is generally linearly formed. On the other hand, the other end portion 12b with the arm link 13 coupled therewith is formed in a curved manner. An insertion hole 12c is formed at a distal end portion of the one end portion 12a in a penetrating manner (refer to FIG. 3). The eccentric shaft portion 10c is rotatably inserted through the insertion hole 12c. The other end portion 12b includes distal end portions 12d formed into a fork-like shape as illustrated in FIG. 5 (a vertical cross-sectional view of an actuator). A coupling hole 12e is formed at the distal end portions 12d. Further, a coupling hole 13c is formed at a protrusion portion 13b of the arm link 13 in a penetrating manner. The coupling hole 13c is generally equal in diameter to the coupling hole 12e. A protrusion portion 13b of the arm link 13 is inserted through between each of the distal end portions 12d formed into the fork-like shape, and a coupling pin 14 penetrates through the coupling holes 12e and 13c and is fixedly press-fitted in this state.

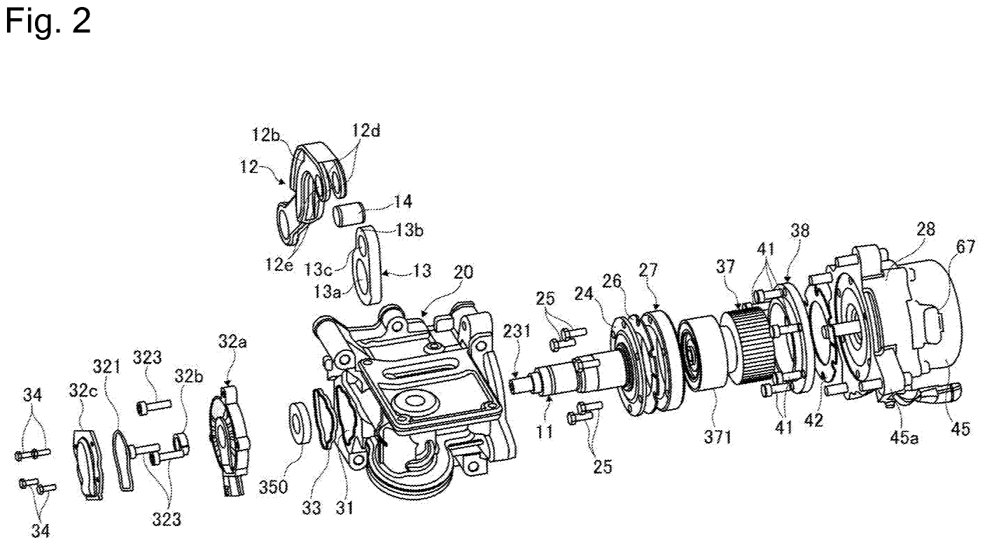

The arm link 13 is formed as a different member from the second control shaft 11 as illustrated in FIG. 2 (an exploded perspective view of the actuator). The arm link 13 is a thick member made from a ferrous metallic material and includes an annular portion and the protrusion portion 13b. A press-fitting hole 13a is formed at an approximately central position of the annular portion in a penetrating manner. The protrusion portion 13b protrudes toward an outer periphery. A fixation portion 23b of the second control shaft 11 is press-fitted in the press-fitting hole 13a, and the second control shaft 11 and the arm link 13 are fixed by this press-fitting. The coupling hole 13c is formed at the protrusion portion 13b. The coupling pin 14 is rotatably supported in the coupling hole 13c. A central axis of the coupling hole 13c (a central axis of the coupling pin 14) is radially eccentric from a rotational axis O of the second control shaft 11 by a predetermined amount.

A rotational angle of the second control shaft 11 is changed by a torque transmitted from an electric motor 22 via a strain wave gearing speed reducer 21, which is a part of the actuator of the variable compression ratio mechanism for the internal combustion engine. The second control shaft 11 rotates within a predetermined angular range narrower than 360 [degrees] (for example, approximately 150 [degrees]). The change in the rotational angle of the second control shaft 11 causes a change in a posture of the second control link 12 and thus a rotation of the first control shaft 10, thereby causing a change in a position of the lower end portion of the first control link 7. This results in a change in a posture of the lower link 5 and thus a change in a stroke position and a stroke amount of the piston 1 in the cylinder, thereby leading to a change in a compression ratio of the internal combustion engine according thereto.

Next, a configuration of the actuator of the variable compression ratio mechanism for the internal combustion engine according to the first embodiment will be described.

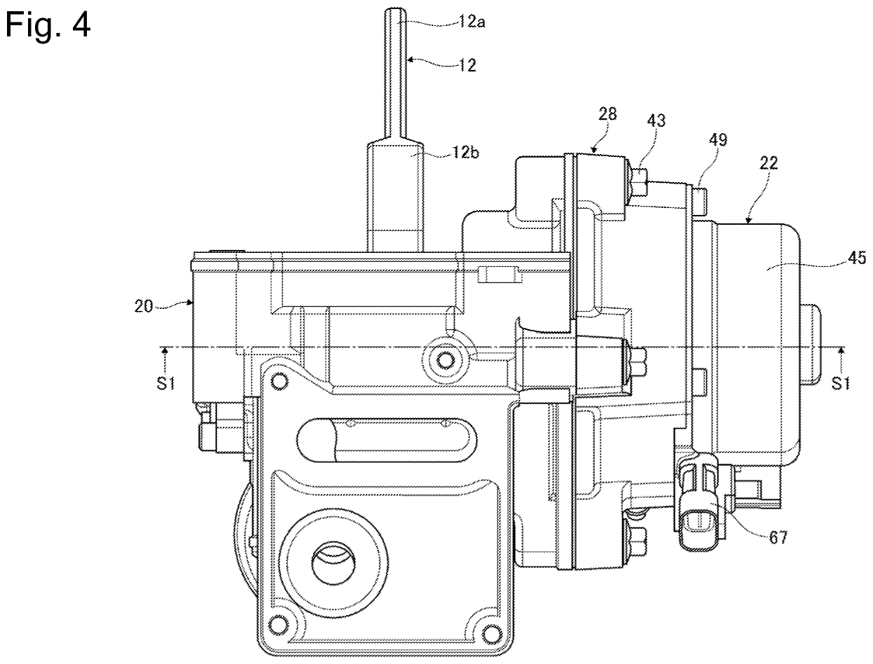

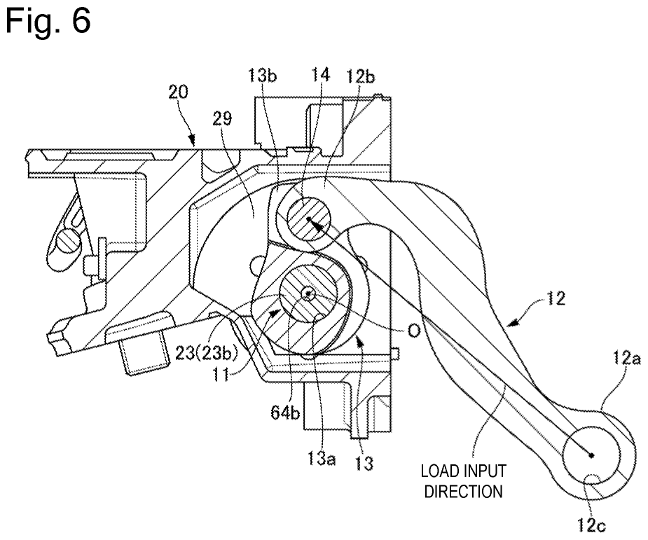

FIG. 2 is an exploded perspective view of the actuator of the variable compression ratio mechanism for the internal combustion engine according to the first embodiment. FIG. 3 is a perspective view of the actuator of the variable compression ratio mechanism for the internal combustion engine according to the first embodiment. FIG. 4 is a plan view of the actuator of the variable compression ratio mechanism for the internal combustion engine according to the first embodiment. FIG. 5 is a cross-sectional view taken along a line indicated by arrows S1 and S1 illustrated in FIG. 4. FIG. 6 is a cross-sectional view taken along a line indicated by arrows S2 and S2 illustrated in FIG. 5. As illustrated in FIGS. 2 to 6, the actuator of the variable compression ratio mechanism for the internal combustion engine includes the electric motor 22, the strain wave gearing speed reducer 21, the housing 20, and the second control shaft 11. The strain wave gearing speed reducer 21 is attached to a distal end side of the electric motor 22. The housing 20 contains the strain wave gearing speed reducer 21 therein. The second control shaft 11 is rotatably supported on the housing 20.

The electric motor 22 is a brushless motor, and includes a motor casing 45, a coil 46, a rotor 47, a motor driving shaft 48, and a resolver 55. The motor housing 45 is formed into a bottomed cylindrical shape. The motor casing 45 includes four boss portions 45a on an outer periphery of a front end thereof. A bolt insertion hole 45b penetrates through each of the boss portions 45a. A bolt 49 is inserted through the bolt insertion hole 45b. The coil 46 is formed into a cylindrical or tubular shape, and is fixed to an inner peripheral surface of the motor casing 45. The rotor 47 is rotatably provided inside the coil 46. One end portion 48a of the motor driving shaft 48 is fixed to a center of the rotor 47. The motor driving shaft 48 is rotatably supported by a ball bearing 52 provided at a bottom portion of the motor casing 45.

The resolver 55 detects a rotational angle of the motor driving shaft 48. The resolver 55 is provided at a position protruding from an opening of the motor casing 45. The resolver 55 includes a resolver rotor 55a and a sensor portion 55b. The resolver rotor 55a is fixedly press-fitted to an outer periphery of the motor driving shaft 48. The sensor portion 55b detects a multi-toothed target (not illustrated) formed an outer peripheral surface of the resolver motor 55a. The sensor portion 55b outputs a detection signal to a not-illustrated control unit. The sensor portion 55b is fixed inside a cover 28 with use of two screws. When the motor casing 45 is attached to the cover 28, the bolts 49 are inserted through the boss portions 45a while an O-ring 51 is interposed between an end surface of the resolver 55 and the cover 28. Subsequently, the bolts 49 are tightened to male screw portions formed on the electric motor 22 side of the cover 28. A motor containing chamber, which contains the electric motor 22 by the motor casing 45 and the cover 28, is a drying chamber to which lubricant oil or the like is not supplied.

The second control shaft 11 includes a shaft portion main body 23 and a fixation flange 24. The fixation flange 24 is formed into a generally disk-like shape larger in diameter than the shaft portion main body 23. On the second control shaft 11, the shaft portion main body 23 and the fixation flange 24 are integrally formed from a ferrous metallic material. The shaft portion main body 23 includes a sensor shaft portion 231 and a retainer shaft portion 232. The sensor shaft portion 231 is located on an inner periphery of an angle sensor 32. A retainer 350 is fixedly press-fitted to the retainer shaft portion 232. The retainer 350 is larger in diameter than the sensor shaft portion 231, and restricts a movement to the strain wave gearing speed reducer side in a direction of the rotational axis O of the second control shaft 11 (an axial direction) (refer to FIG. 5).

Further, the second control shaft 11 includes a first journal portion 23a, a fixation portion 23b, and a second journal portion 23c on the strain wave gearing speed reducer side with respect to the retainer shaft portion 232. The first journal portion 23a is located on a distal end portion side of the second control shaft 11. The fixation portion 23b is press-fitted into the press-fitting hole 13a of the arm link 13 from the first journal portion 23a side. The second journal portion 23c is located on the fixation flange 24 side of the second control shaft 11. The first journal portion 23a is smaller in diameter than the fixation portion 23b, and the second journal portion 23c is larger in diameter than the fixation portion 23b. A first stepped portion 23d is formed between the fixation portion 23b and the second journal portion 23c. A second stepped portion 23e is formed between the first journal portion 23a and the fixation portion 23b. A third stepped portion 23f is formed between the first journal portion 23a and the retainer shaft portion 232. The third stepped portion 23f serves as a stopper when the retainer 350 is press-fitted into the retainer shaft portion 232, and facilitates the press-fitting process.

When the fixation portion 23b is press-fitted into the press-fitting hole 13a of the arm link 13 from the first journal portion 23a side, an end portion of the press-fitting hole 13a on one side on the second journal portion 23c side abuts against the first stepped portion 23d from the axial direction. By this abutment, the first stepped portion 23d restricts a movement of the arm link 13 to the second journal portion 23c side. On the other hand, the second stepped portion 23e restricts a movement of the second control shaft 11 in the axial direction to an opposite side from the strain wave gearing speed reducer 21 side by abutting against a stepped hole edge portion 30c of a support hole 30 and a metallic bush 301 when the shaft portion main body 23 is inserted through the support hole 30 formed in the housing 20. The shaft portion main body 23 is supported rotatably and slightly axially movably in a first bearing hole 301a of the metallic bush 301 and a second bearing hole 304a of a metallic bush 304. In other words, a slight radial space is generated between an inner periphery of the first bearing hole 301a and an outer periphery of the first journal portion 23a and an inner periphery of the second bearing hole 304a and the second journal portion 23c. Lubricant oil pressure-fed from an oil pump is introduced into between the first bearing hole 301a and the first journal portion 23a and between the second bearing hole 304a and the second journal portion 23c. A specific structure for introducing the lubricant oil will be described below. The fixation flange 24 includes six bolt insertion holes 24a formed at even intervals in a circumferential direction of an outer peripheral portion thereof. The fixation flange 24 is coupled with a strain wave gear output shaft member 27, which is internal teeth of the strain wave gearing speed reducer 21, via a thrust plate 26 by inserting six bolts 25 through these bolt insertion holes 24a.

The second control shaft 11 includes an introduction portion for introducing the lubricant oil press-fed from the not-illustrated oil pump. The introduction portion includes an axial oil passage 64a and an oil chamber 64b. The axial oil passage 64a penetrates through a center of the second control shaft 11 axially. The lubricant oil is supplied into the axial oil passage 64a via a not-illustrated oil passage formed on the housing 20. The oil chamber 64b is formed at a center of the fixation flange 24 and the lubricant oil is supplied from the axial oil passage 64a thereto. A narrow hole member 400 is press-fitted in an end portion of the axial oil passage 64a on the oil chamber 64b side. A narrow hole 401 penetrates through a center of the narrow hole member 400.

The narrow hole 401 has a smaller area in cross section in a direction perpendicular to the shaft than an area of the axial oil passage 64a in cross section in the direction perpendicular to the shaft. Therefore, the narrow hole 401 functions as an orifice. By this configuration, even when the large-diameter axial oil passage 64a is formed from the oil chamber 64b side, an orifice effect can be exerted due to the narrow hole 401 provided near a lubricant oil discharge port on the oil chamber 64b side, and the lubricant oil can be spread in the oil chamber 64b. The lubrication oil supplied into the oil chamber 64b is supplied to the strain wave gearing speed reducer 21. The second control shaft 11 includes a radial oil passage 65a, which is in communication with the axial oil passage 64a. The radial oil passage 65a is in communication with an oil hole 65b formed inside the arm link 13. The radial oil passage 65a supplies the lubricant oil into between an inner peripheral surface of the coupling hole 13c and the coupling pin 14 via the oil hole 65b.

The housing 20 is formed into a generally cubic shape with use of an aluminum alloy material. A large-diameter annular opening groove portion 20a is formed at a rear end side of the housing 20. This opening groove portion 20a is closed by the cover 28 via the O-ring 51. The cover 28 includes a motor shaft through-hole 28a and four boss portions 28b. The motor driving shaft 48 penetrates through a center of the motor shaft through-hole 28a. The boss portions 28b have diameters increasing toward a radially outer peripheral side. The cover 28 and the housing 20 are fixedly fastened to each other with bolts 43 inserted through bolt insertion holes formed at the boss portions 28b in a penetrating manner. An opening for the second control link 12 coupled with the arm link 13 is formed on a side surface perpendicular to an opening direction of the opening groove portion 20a. A containing chamber 29 is formed inside the housing 20 with this opening formed thereon. The containing chamber 29 serves as a working area of the arm link 13 and the second control link 12. A speed reducer-side through-hole 30b is formed between the opening groove portion 20a and the containing chamber 29. The second journal portion 23c of the second control shaft 11 penetrates through the speed reducer-side through-hole 30b. The support hole 30 is formed on an axial side surface of the containing chamber 29. The first journal portion 23a of the second control shaft 11 penetrates through the support hole 30. The metallic bush 301 is disposed between the support hole 30 and the first journal portion 23a, and the metallic bush 304 is disposed between the support hole 30b and the second journal portion 23c.

A retainer containing hole 31 is formed at an end portion of the support hole 30 on the angle sensor 32 side. The retainer containing hole 31 is formed so as to have a larger diameter than the opening of the support hole 30. A stepped surface 31a is formed between an opening of the support hole 30 on the angle sensor 32 side and the retainer containing hole 31. The stepped surface 31a extends in a direction perpendicular to the axial direction of the second control shaft 11. The retainer 350 restricts a movement of the second control shaft 11 to the strain wave gearing speed reducer side in the axial direction by abutting against the stepped surface 31a. A lubricant oil return flow oil passage 201 is provided below the retainer containing hole 31. The lubricant oil return flow oil passage 201 is in communication with the retainer containing hole 31, and also returns the lubricant oil to the containing chamber 29 side.

The angle sensor 32 includes a sensor holder 32a. The sensor holder 32a is attached so as to close the retainer containing hole 31 from outside the housing 20. The sensor holder 32a includes a through-hole 32a 1 and a flange portion 32a 2. A detection coil is disposed on an inner peripheral portion of the through-hole 32a 1. The flange portions 32a 2 is fixed to the housing 20 with use of a bolt. A seal ring 33 is mounted between the sensor holder 32a and the housing 20. The seal ring 33 ensures liquid-tightness between the retainer containing hole 31 and the outside. The sensor holder 32a includes a sensor cover 32c on an outer peripheral side thereof. The sensor cover 32c closes the through-hole 32a 1. A seal ring 323 is mounted between the sensor cover 32c and the sensor holder 32a. The seal ring 323 ensures liquid-tightness between the retainer containing hole 31 and the through-hole 321a 1 and the outside. A sensor shaft portion 231 is inserted in the through-hole 32a 1. A rotor 32b is attached to an outer periphery of the sensor shaft portion 231. The rotor 32b is a generally elliptic component. The angle sensor 32 detects a change in a distance set between an inner periphery of the through-hole 32a 1 and the rotor 32b due to a rotation of the rotor 32b based on a change in inductance of the detection coil. By this detection, the angle sensor 32 detects a rotational position of the rotor 32b, i.e., a rotational angle of the second control shaft 11. The angle sensor 32 is a so-called resolver sensor as described above, and outputs rotational angle information to the not-illustrated control unit that detects an engine operation state.

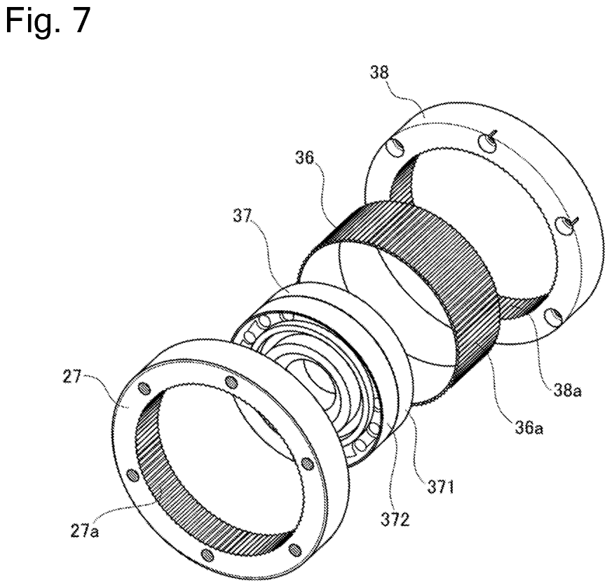

FIG. 7 is an exploded perspective view of the strain wave gearing speed reducer according to the first embodiment. The strain wave gearing speed reducer 21 is a harmonic drive (registered trademark) speed reducer, and each component thereof is contained in the opening groove portion 20a of the housing 20 that is closed by the cover 28. The strain wave gearing speed reducer 21 includes the first strain wave gear output shaft member 27, a flexible external gear 36, a wave generator 37, and a second strain wave gear fixation shaft member 38. The first strain wave gear output shaft member 27 is fastened to the fixation flange 24 of the second control shaft 11 with use of a bolt. The first strain wave gear output shaft member 27 is annularly formed, and includes a plurality of internal teeth 27a formed on an inner periphery thereof. The flexible external gear 36 is disposed on a radially inner side of the first strain wave gear output shaft member 27. The flexible external gear 37 is deflectably deformable, and includes external teeth 36a meshed with the internal teeth 27a on an outer peripheral surface thereof. The wave generator 36 is elliptically formed, and an outer peripheral surface thereof slidably moves along an inner peripheral surface of the flexible external gear 36. The second strain wave gear fixation shaft member 38 is disposed on the outer peripheral side of the flexible external gear 36, and includes internal teeth 38a meshed with the external teeth 36a on an inner peripheral surface thereof.

Male screw holes 27b, which serve as nut portions of the individual bolts 25, are formed at positions at even intervals in the circumferential direction on an outer peripheral side of the first strain wave gear output shaft member 27. The flexible external gear 36 is made from a metallic material, and is formed into a deflectably deformable thin cylindrical shape. The number of teeth of the external teeth 36a of the flexible external gear 36 is equal to the number of teeth of the internal teeth 27a of the first strain wave gear output shaft member 27.

The wave generator 37 includes a main body portion 371 and a ball bearing 372. The main body portion 371 has an elliptic shape. The ball bearing 372 permits a relative rotation between an outer periphery of the main body portion 371 and the inner periphery of the flexible external gear 36. A through-hole 37a is formed through a center of the main body portion 371. A serration is formed on an inner periphery of the through-hole 37a, and is coupled with an outer periphery of the other end portion 48b of the motor driving shaft 48 by serration coupling. This coupling may be achieved by coupling using a keyway or spline coupling instead of the serration coupling. A cylindrical portion 371b is formed on an electric motor-side side surface 371a of the main body portion 371. The cylindrical portion 371b protrudes toward the electric motor side so as to surround an outer periphery of the through-hole 37a. The cylindrical portion 371b has a perfect circular shape in cross section, and an outer periphery of the cylindrical portion 371b has a smaller diameter than a minor axis of the main body portion 371.

A flange 38b is formed on an outer periphery of the second strain wave gear fixation shaft member 38. The flange portion 38b is used for fastening to the cover 28. Six bolt through-holes 38c are formed through the flange 38b in a penetrating manner. The second strain wave gear fixation shaft member 38 and a second thrust plate 42 are fixedly fastened to the cover 28 by placing the second thrust plate 42 between the second strain wave gear fixation shaft member 38 and the cover 28 and inserting a bolt 41 through each of the bolt insertion holes 38c. The second thrust plate 42 is made from a ferrous metallic material as wear-resistant as or more wear-resistant than the flexible external teeth 36. Due to this configuration, the actuator prevents the cover 28 from being worn due to a thrust force generated on the flexible external gear 36, and also regulates an axial position of a ball bearing 700. The ball bearing 700 is an open-type ball bearing, and a four-point contact roller bearing that can receive a load in the thrust direction. The ball bearing 700 permits a relative rotation of the main body portion 371 relative to the cover 28. The second thrust plate 42 is an annular disk-like member, and is formed in such a manner that an inner peripheral-side edge portion 42a thereof is located on the rotational axis O side with respect to an inner periphery of an outer race of the ball bearing 700. The number of teeth of the internal teeth 38a of the second strain wave gear fixation shaft member 38 is greater than the number of teeth of the external teeth 36a of the flexible external gear 36 by two. Therefore, the number of teeth of the internal teeth 38a of the second strain wave gear fixation shaft member 38 is greater than the number of teeth of the internal teeth 27a of the first strain wave gear output shaft member 27 by two. A speed reduction ratio of the strain wave gearing speed reduction mechanism is determined according to this difference between the numbers of teeth, and therefore a significantly high speed reduction ratio can be acquired.

The cover 28 includes a female screw portion 28c, a plate containing portion 281a, a bearing containing portion 281b, and a seal containing portion 281d on an end surface 281 on the strain wave gearing speed reducer 21 side. The bolt 41 is threadably engaged with the female screw portion 28c. The plate containing portion 281a has approximately the same depth as a thickness of the second thrust plate 42, and houses the second thrust plate 42 therein. The seal containing portion 281b is a bottomed cylindrical stepped portion formed by being bent from the plate containing portion 281a from the electric motor 22 side. The seal containing portion 281d is formed into a cylindrical shape protruding toward the wave generator 37 side on a radially inner side of a bottom surface 281c of the bearing containing portion 281b.

The seal containing portion 281d is provided on a radially inner side of the cylindrical portion 371b on the main body portion 371. The seal containing portion 281d is smaller in diameter than an inner peripheral surface of the cylindrical portion 371b. A seal member 310 is provided between an inner periphery of the seal containing portion 281d and the outer periphery of the motor driving shaft 48. The seal member 310 liquid-tightly seals between the opening groove portion 20a containing the strain wave gearing speed reducer 21 and the electric motor 22. The seal containing portion 281d axially protrudes on a radially inner side of the cylindrical portion 371b.

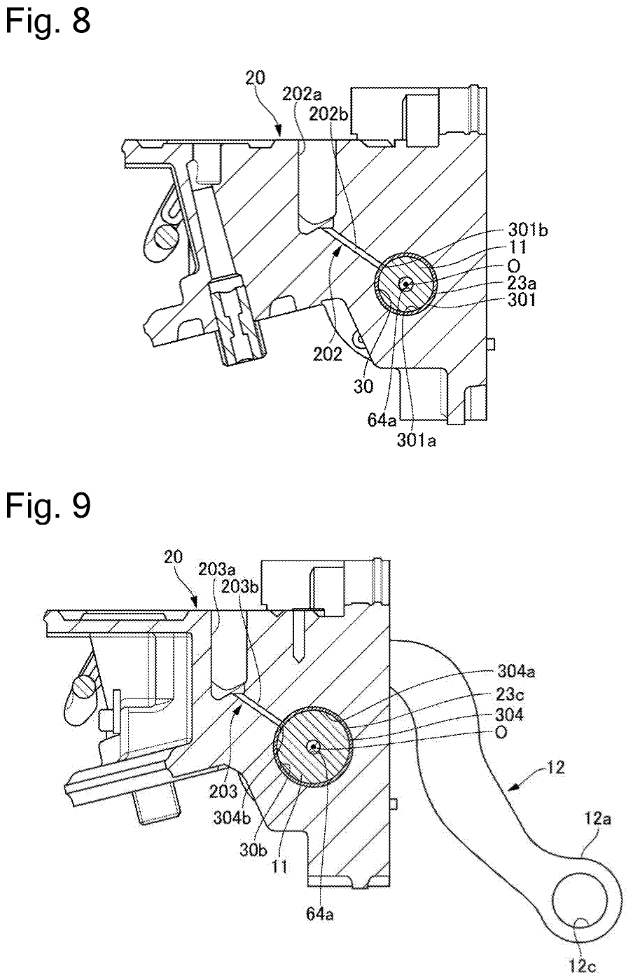

Next, the structure for introducing the lubricant oil into between the first bearing hole 301a and the first journal portion 23a and between the second bearing hole 304a and the second journal portion 23c will be described. FIG. 8 is a cross-sectional view taken along a line S3-S3 illustrated in FIG. 5 according to a second embodiment.

A lubricant oil supply oil passage 202 for introducing the lubricant oil pressure-fed from the oil pump is formed on the housing 20 and the metallic bush 301. The lubricant oil supply oil passage 202 includes a first oil passage 202a, a second oil passage 202b, and an oil hole 301b. The first oil passage 202a and the second oil passage 202b are formed in the housing 20. The first oil passage 202a extends downward from an end surface of the housing 20 on a vertically upper side. The second oil passage 202b connects the first oil passage 202a and the support hole 30 to each other therebetween. The second oil passage 202b extends from a lower end of the first oil passage 202a toward the central axis of the support hole 30. The second oil passage 202b is arranged at some angle with respect to the vertical direction. The oil hole 301b is formed on the metallic bush 301. The oil hole 301b is continuous from the second oil passage 202b, and is in communication with the first bearing hole 301a. The oil hole 301b is concentric with and the same in diameter as the second oil passage 202b. An opening of the lubricant oil supply oil passage 202 on the first bearing hole 301a side (an opening of the oil hole 301b on the first bearing hole 301a side) is opened in a pressure-receiving range over which a contact pressure is received from the second control shaft 11 during an expansion stroke of the internal combustion engine as viewed from the axial direction. As will be used herein, “a contact pressure is received” includes when a load is received via an oil film besides when the load is directly received from a surface contact. The “pressure-receiving range” will be described below.

FIG. 9 is a cross-sectional view taken along a line indicated by arrows S4 and S4 illustrated in FIG. 5.

A lubricant oil supply oil passage 203 for introducing the lubricant oil pressure-fed from the oil pump is formed on the housing 20 and the metallic bush 304. The lubricant oil supply oil passage 203 includes a first oil passage 203a, a second oil passage 203b, and an oil passage 304b. The first oil passage 203a and the second oil passage 203b are formed in the housing 20. The first oil passage 203a extends downward from the end surface of the housing 20 on the vertically upper side. The second oil passage 203b connects the first oil passage 203a and the support hole 30b to each other therebetween. The second oil passage 203b extends from a lower end of the first oil passage 203a toward the central axis of the support hole 30b. The second oil passage 203b is arranged at some angle with respect to the vertical direction. The oil hole 304b is formed on the metallic bush 304. The oil hole 304b is continuous from the second oil passage 203b, and is in communication with the second bearing hole 304a. The oil hole 304b is concentric with and the same in diameter as the second oil passage 203b. An opening of the lubricant oil supply oil passage 203 on the second bearing hole 304a side (an opening of the oil hole 304b on the second bearing hole 304a side) is opened in the pressure-receiving range over which the contact pressure is received from the second control shaft 11 during an expansion stroke of the internal combustion engine as viewed from the axial direction.

Next, the pressure-receiving range will be described.

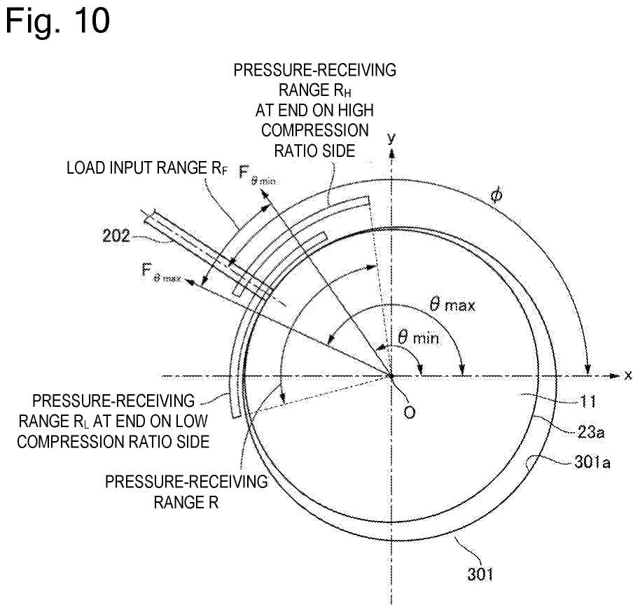

FIG. 10 schematically illustrates the actuator with the second control shaft 11 and the metallic bush 301 in surface contact with each other. In FIG. 10, two-dimensional coordinates are set with an origin thereof placed at the rotational axis O.

When the internal combustion engine is in operation, the load applied to the second control shaft 11 mainly consists of an alternate load due to an operation inertia (an inertial force) of the variable compression ratio mechanism when the internal combustion engine is subjected to a low load. On the other hand, when the internal combustion engine is subjected to a high load, the load applied to the second control shaft 11 mainly consists of a pulsating load (a unidirectional load) input to the second control shaft 11 because the variable compression ration mechanism receives an explosion force of the internal combustion engine due to an increase in the explosion force during the expansion stroke. In FIG. 6, when the explosion force of the internal combustion engine is applied to the variable compression ratio mechanism, a direction in which the load is input to the second control shaft 11 is determined based on a direction in which the load is input to the coupling pin 14. The load is input to the coupling pin 14 in a direction from the one end portion 12a to the other end portion 12b of the second control link 12, but this direction changes according to the rotational angle of the second control shaft 11. Therefore, the direction in which the load is input to the second control shaft 11 changes within a range (a load input range) RF between a minimum angle θₘᵢₙ and a maximum angle θₘₐₓ illustrated in FIG. 10. The load input range R_{F} is, for example, approximately 15 [degrees]. The minimum angle θₘᵢₙ is a rotational angle when the second control shaft 11 rotates maximumly in a direction in which the internal combustion engine has a high compression ratio. At this time, the first bearing hole 301a receives a load Femin, and the first bearing hole 301a receives the contact pressure from the second control shaft 11 over a high compression ratio-side pressure-receiving range R_{H}. On the other hand, θₘₐₓ is a rotational angle when the second control shaft 11 rotates maximumly in a direction in which the internal combustion engine has a low compression ratio. At this time, the first bearing hole 301a receives a load F_{θmax}, and the first bearing hole 301a receives the contact pressure from the second control shaft 11 over a low compression ratio-side pressure-receiving range R_{L}. Hereinafter, a clockwise direction and a counterclockwise direction in FIG. 10 will be referred to as the high compression ratio side and the low compression ratio side in the pressure-receiving range R, respectively.

In FIG. 10, the pressure-receiving range R is a continuous single range including the high compression ratio-side end pressure-receiving range R_{H} and the low compression ratio-side end pressure-receiving range R_{L}. The pressure-receiving range R is expressed by the following equation (1) with use of θₘᵢₙ and θₘₐₓ.

R=θₘᵢₙ−(ξ_{H}/2)˜θₘₐₓ+(ξ_{L}/2) (1)

In the equation (1), ξ_{H} [degrees] represents a value acquired by converting a width Lc_{H} [mm] of the pressure-receiving range R_{H} at an end on the high compression ratio side in a circumferential direction of the first bearing hole 301a into an angle. Further, ξ_{L} [degrees] represents a value acquired by converting a width Lc_{L} [mm] of the pressure-receiving range R_{L} at an end on the low compression ratio side in the circumferential direction of the first bearing hole 301a into an angle. Then, ξ_{H} and ξ_{L} are acquired from the following equation (2).

ξ_{H(L)}=360×Lc_{H(L)}/Ld (2)

In the equation (2), Ld [mm] represents a perimeter of the first bearing hole 301a, and is expressed by the following equation (3).

Ld=π×D (3)

In the equation (3), D represents a diameter of the first bearing hole 301a.

Then, the width Lox and the width Lc_{L} can be calculated with use of the following equation (4) based on the Hertzian theory of elastic contact.

$$\begin{matrix}[ Equation 1 ] & \\ Lc = 2 \times \sqrt{\frac{4}{π} \times \frac{r 1 \times r 2}{r 2 - r 1} \times ( \frac{1 - v {1}^{2}}{E 1} + \frac{1 - v {2}^{2}}{E 2} ) \times \frac{F}{L}} & ( 4 )\end{matrix}$$

In the equation (4), r1 represents a radius [mm] of the second control shaft 11, r2 represents a radius [mm] of the first bearing hole 301a, v1 represents a Poisson's ratio of the second control shaft 11, v2 represents a Poisson's ratio of the first bearing hole 301a, E1 represents a Young's modulus [MPa] of the second control shaft 11, E2 represents a Young's modulus [MPa] of the first bearing hole 301a, F represents the load [N] input to the second control shaft 11 (=the load received by the first bearing hole 301a), and L represents an axial length [mm] of the first bearing hole 301a.

The width Lc_{H} and the width L_{cL} can be calculated by substituting F_{θmin} and F_{θmax} for F in the equation (4).

The pressure-receiving range R can be easily and accurately calculated from the input load F to the second control shaft 11 by using the equation (1). Then, the lubricant oil can be supplied to the pressure-receiving range R by setting an opening position (angle) φ of the lubricant oil supply oil passage 202 in the first bearing hole 301a to the pressure-receiving range R acquired from the equation (1). In the first embodiment, the lubricant oil supply oil passage 202 is opened on the low compression ratio side (a position closer to the maximum angle θₘₐₓ) with respect to an intermediate position in the pressure-receiving range R. Further, the lubricant oil supply oil passage 202 is located on the vertically upper side with respect to the rotational axis O with the variable compression ratio apparatus for the internal combustion engine mounted on the vehicle.

Now, the pressure-receiving range R may also be calculated with use of the following equation (5) instead of the equation (1).

R=θₘᵢₙ−90˜θₘₐₓ+90 (5)

The pressure-receiving range R increases as the clearance (the radial space) between the first bearing hole 301a and the second control shaft 11 reduces. Then, the pressure-receiving range R exceeds the range according to the equation (5) when the clearance is minimized, but it is revealed from an experiment result that the pressure-receiving range R falls within the range according to the equation (5) when the clearance is set to an optimum range in consideration of operability and assemblability. Therefore, the use of the equation (5) eliminates the necessity of the input load F when calculating the pressure-receiving range R, thereby being able to facilitate the calculation of the pressure-receiving range R. In other words, the operability and assemblability of the actuator can be optimized by setting the clearance between the first bearing hole 301a and the second control shaft 11 in such a manner that the pressure-receiving range R satisfies the range according to the equation (5).

The same also applied to a pressure-receiving range on the metallic bush 304 side, and therefore the illustration and description thereof will be omitted herein.

Next, functions and effects of the first embodiment will be described.

When the internal combustion engine is subjected to a high load, the second control shaft 11 is pressed in one direction from the arm link 13 due to the pulsating load applied from the internal combustion engine to the variable compression ratio mechanism. According thereto, the first bearing hole 301a receives a locally high contact pressure from the second control shaft 11. When the lubricant oil cannot be sufficiently introduced into this portion, i.e., the pressure-receiving range R, friction is facilitated between the second control shaft 11 and the first bearing hole 301a, and therefore durability may be deteriorated. Then, even introducing the lubricant oil into a portion having a wide clearance (a portion where the contact pressure is low) cannot satisfy sufficient supply of the lubricant oil to the pressure-receiving range R due to the smaller rotational range of the second control shaft 11 than 360 [degrees] and the extremely narrow clearance of the pressure-receiving range R.

On the other hand, the housing 20 according to the first embodiment includes the lubricant oil supply oil passage 202 opened to the pressure-receiving range R over which the contact pressure is received at the first bearing hole 301a from the second control shaft 11 during the expansion stroke of the internal combustion engine. The pressure-receiving range R is a portion over which the first bearing 301a receives a high contact pressure when the rotational angle of the second control shaft 11 is at least one angle. Therefore, the lubricant oil can be sufficiently supplied to the portion where the high contact pressure is applied by directly introducing the lubricant oil into this portion. As a result, the friction can be prevented or reduced between the second control shaft 11 and the first bearing hole 301a, and therefore the durability can be improved. The same also applies to the lubricant oil supply oil passage 203.

The lubricant oil supply oil passage 202 is opened at the position deviated from the circumferentially central position of the pressure-receiving range R toward the low compression ratio side. The internal combustion engine can increase thermal efficiency as the compression ratio increases, but abnormal combustion suck as knocking easily occurs when the internal combustion engine is subjected to a high load. Therefore, the variable compression ratio mechanism increases the compression ratio at the time of a low load, which allows the compression ratio to increase, and reduces the compression ratio at the time of a high load, which easily leads to occurrence of knocking, with the aim of maximizing a reduction in fuel consumption due to the increase in the compression ratio. In other words, a higher contact pressure is applied to the first bearing hole 301a as the compression ratio reduces, and therefore lubricity can be effectively improved between the second control shaft 11 and the first bearing hole 301a by supplying the lubricant oil to the position where a high contact pressure is applied in the pressure-receiving range R. The same also applies to the lubricant oil supply oil passage 203.

The lubricant oil supply oil passage 202 is located on the vertically upper side with respect to the rotational axis O of the second control shaft 11 in the state mounted on the vehicle. This layout facilitates a downward descent of the lubricant oil in the lubricant oil supply oil passage 202 with the aid of its own weight. Therefore, the lubricant oil can be efficiently supplied to the pressure-receiving range R, and therefore the lubricity can be improved between the second control shaft 11 and the first bearing hole 301a. The same also applies to the lubricant oil supply oil passage 204.

The lubricant oil supply oil passage 202 is opened to the first bearing hole 301a of the metallic bush 301, and the lubricant oil supply oil passage 203 is opened to the second bearing hole 304a of the metallic bush 304. Due to this configuration, the lubricant oil can lubricate each of the pressure-receiving ranges R of the two metallic bushes 301 and 304.

### Second Embodiment

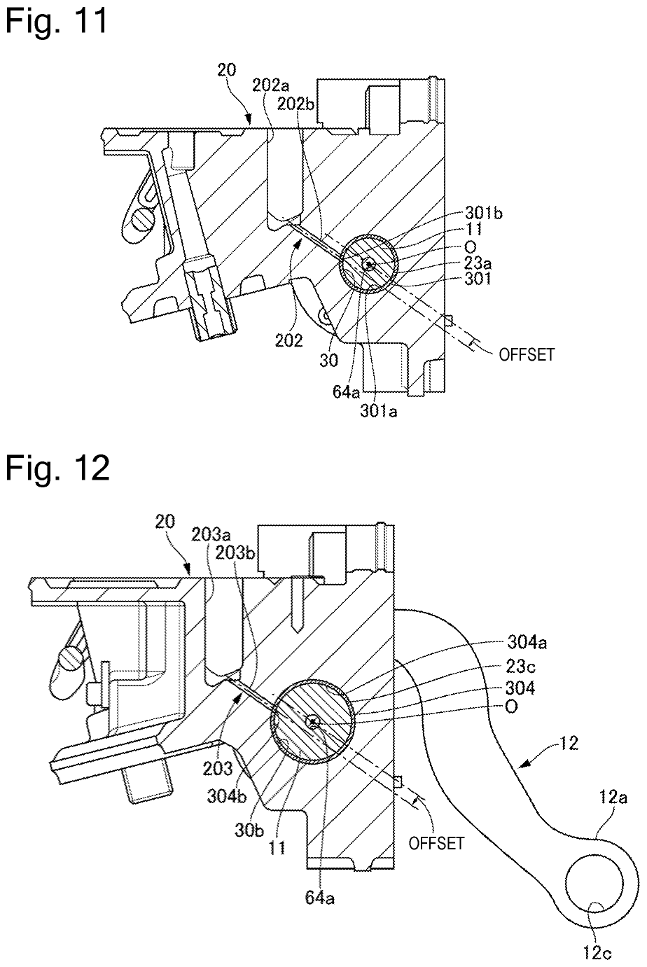

The second embodiment has a basic configuration similar to the first embodiment, and therefore will be described focusing only on differences therefrom. FIG. 11 is a cross-sectional view taken along the line indicated by the arrows S3-S3 illustrated in FIG. 5 according to the second embodiment. FIG. 12 is a cross-sectional view taken along the line indicated by the arrows S4-S4 illustrated in FIG. 5 according to the second embodiment. The second oil passage 202b of the lubricant oil supply oil passage 202 is offset from the radial direction of the first bearing hole 301a. Similarly, the second oil passage 203b of the lubricant oil supply oil passage 203 is offset from the radial direction of the second bearing hole 304a. This configuration can increase an area of the opening of the lubricant oil supply oil passage 202 in the first bearing hole 301a, thereby increasing a supply amount of the lubricant oil, compared to the second oil passage 202b according to the first embodiment. The same advantageous effects can also be brought about with respect to the second oil passage 203b.

### Third Embodiment

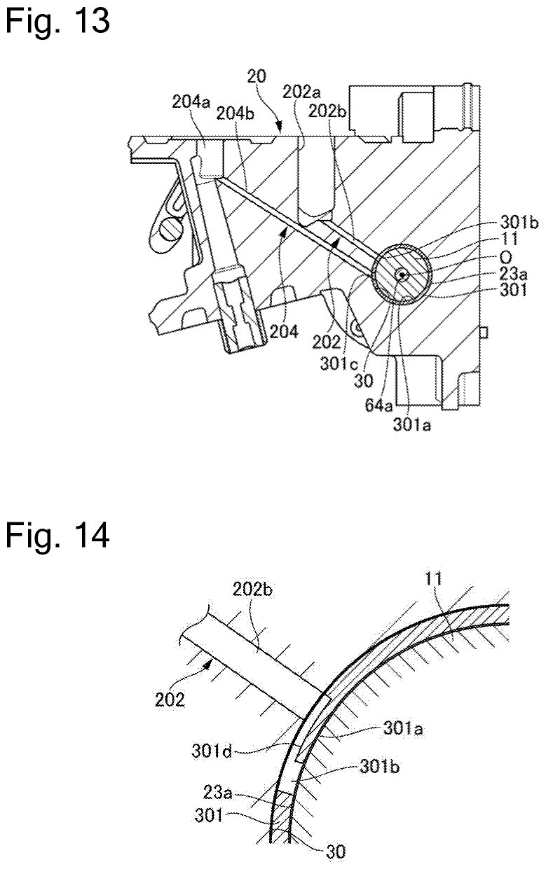

The third embodiment has a basic configuration similar to the first embodiment, and therefore will be described focusing only on differences therefrom. FIG. 13 is a cross-sectional view taken along the line indicated by the arrows S3 and S3 illustrated in FIG. 5 according to the third embodiment. A lubricant oil supply oil passage 204 includes a first oil passage 204a, a second oil passage 204b, and an oil hole 301c. The first oil passage 204a and the second oil passage 204b are formed in the housing 20. The first oil passage 204a is opened at a different position from the lubricant oil supply oil passage 202 on the end surface of the housing 20 on the vertically upper side. The oil hole 301c is formed on the metallic bush 301. An opening of the lubricant oil supply oil passage 204 on the first bearing hole 301a side (an opening of the oil hole 301c on the first bearing hole 301a side) is located on the low compression ratio side with respect to the opening of the lubricant oil supply oil passage 202. The same also applies to the metallic bush 304 side although the illustration thereof is omitted. In the third embodiment, the lubricant oil can be supplied from the two lubricant oil supply oil passages 202 and 204 to the single pressure-receiving range R of the first bearing hole 301a, and therefore the lubricant oil can be supplied by a larger amount. Further, the lubricant oil can be supplied to each of the high compression ratio side and the low compression ratio side of the pressure-receiving range R, and therefore the lubricant oil can be supplied in a wider range. The same advantageous effects can also be brought about with respect to the metallic bush 304 side.

### Fourth Embodiment

A fourth embodiment has a basic configuration similar to the first embodiment, and therefore will be described focusing only on differences therefrom. FIG. 14 is an enlarged view of main portions in cross section taken along the line indicated by the arrows S3 and S3 illustrated in FIG. 5 according to the fourth embodiment. An oil hole 301b radially penetrating through the metallic bush 301 is located on the low compression ratio side with respect to the opening of the second oil passage 202b on the support hole 30 side. An oil groove 301d is formed on the outer peripheral surface of the metallic bush 301. The oil groove 301d circumferentially extends, and connects the second oil passage 202b and the oil hole 301b to each other therebetween. The same also applies to the metallic bush 304 side although the illustration thereof is omitted. In the fourth embodiment, the lubricant oil can be guided to the oil hole 301b via the oil groove 301d, and therefore the lubricant oil supply oil passage 202 and the oil hole 301b can be laid out with higher flexibility. For example, even when the lubricant oil supply oil passage 202 should be handled under restrictions, the position of the oil hole 301b is free from restrictions, and therefore the lubricant oil can be introduced into a desired position in the pressure-receiving range R. Further, the oil groove 301d is formed on the outer peripheral side of the metallic bush 301, and therefore the oil hole 301b can be formed with pinpoint precision. The same advantageous effects can also be brought about with respect to the metallic bush 304 side.

### Fifth Embodiment

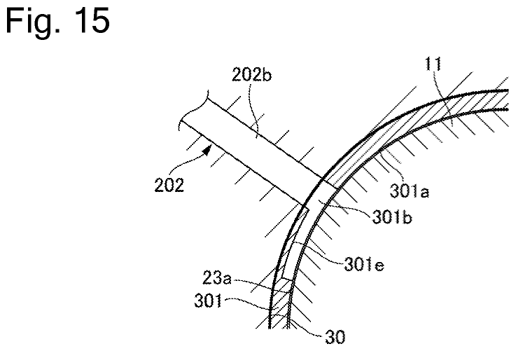

A fifth embodiment has a basic configuration similar to the first embodiment, and therefore will be described focusing only on differences therefrom. FIG. 15 is an enlarged view of main portions in cross section taken along the line indicated by the arrows S3 and S3 illustrated in FIG. 5 according to the fifth embodiment. An oil groove 301e is formed on the inner peripheral surface of the metallic bush 301. The oil groove 301e extends from the oil hole 301b to the high compression ratio side of the pressure-receiving range R. The same also applies to the metallic bush 304 side although the illustration thereof is omitted. In the fifth embodiment, the oil groove 301e is formed on the inner peripheral side of the metallic bush 301, and therefore the lubricant oil can be supplied in a wider range. The same advantageous effects can also be brought about with respect to the metallic bush 304 side.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention.

For example, in the embodiments, the actuator of the variable compression ratio mechanism for the internal combustion engine is employed for the mechanism that makes the compression ratio of the internal combustion engine variable, but the present actuator may be employed for a link mechanism of a variable valve actuating mechanism for an internal combustion engine that makes variable an operation characteristic of an intake valve or an exhaust valve, which is discussed in, for example, Japanese Patent Application Public Disclosure No. 2009-150244.

Further, in the embodiments, the number of teeth of the external teeth 36a of the flexible external gear 36 is set to the same number as the number of teeth of the internal teeth 27a of the first strain wave gear output shaft member 27, but the speed reduction ratio may be adjusted by generating a difference in the number of teeth. In this case, the rotation of the cylindrical portion of the flexible external gear 36 would be transmitted to the second control shaft 11 at a speed reduction ratio according to the difference in the number of teeth between the number of teeth of the external teeth 36a and the number of teeth of the internal teeth 27a.

Further, in the embodiments, the arm link 13 is formed as a different member from the second control shaft 11, but the arm link 13 may be formed integrally with the second control shaft 11.

Three or more lubricant oil supply oil passages may be provided for the single pressure-receiving range.

A groove connecting the oil passage and the pressure-receiving range to each other may be formed on the housing.

In the following description, technical ideas recognizable from the above-described embodiments will be described.

An actuator of a variable compression mechanism for an internal combustion engine, in one configuration thereof, includes an arm link coupled with the variable compression ratio mechanism and configured to change a posture of the variable compression ratio mechanism for the internal combustion engine by swinging, a control shaft including the arm link, an electric motor configured to rotate the control shaft, and a housing including a bearing portion that supports the control shaft and an oil passage opened to a pressure-receiving range over which a contact pressure is received from the control shaft during an expansion stroke of the internal combustion engine in a circumferential direction of the bearing portion.

According to a further preferable configuration, in the above-described configuration, the control shaft is rotatable in a predetermined angular range smaller than 360 degrees. The pressure-receiving range is a continuous single range including one end-side pressure-receiving range over which the bearing portion receives the contact pressure from the control shaft when a rotational angle of the control shaft is located at one end of the predetermined angular range, and another end-side pressure-receiving range over which the bearing portion receives the contact pressure from the control shaft when the rotational angle of the control shaft is located at another end of the predetermined angular range. Now, the one end-side pressure-receiving range corresponds to one of the pressure-receiving range R_{H} at the end on the high compression ratio side and the pressure-receiving range R_{L} at the end on the low compression ratio side, and the other end-side pressure-receiving range corresponds to the other of the pressure-receiving range R_{H} at the end on the high compression ratio side and the pressure-receiving range R_{L} at the end on the low compression ratio side.

According to another preferable configuration, in any of the above-described configurations, the pressure-receiving range is a range acquired by adding, to both ends of a range where a load is input from the control shaft in the circumferential direction of the bearing portion, a half of a width Lc calculated from the following equation,

$$Lc = 2 \times \sqrt{\frac{4}{π} \times \frac{r 1 \times r 2}{r 2 - r 1} \times ( \frac{1 - v {1}^{2}}{E 1} + \frac{1 - v {2}^{2}}{E 2} ) \times \frac{F}{L}} \qquad [ Equation 2 ]$$

in which r1 represents a radius of the control shaft, r2 represents a radius of the bearing, v1 represents a Poisson's ratio of the control shaft, v2 represents a Poisson's ratio of the bearing, E1 represents a Young's modulus of the control shaft, E2 represents a Young's modulus of the bearing, F represents a load input to the control shaft, and L represents a length of the bearing.

According to further another preferable configuration, in any of the above-described configurations, the pressure-receiving range is a range acquired by adding 90 degrees to both ends of a range where a load is input from the control shaft in the circumferential direction of the bearing portion.

According to further another preferable configuration, in any of the above-described configurations, the oil passage is opened at a position deviated from a circumferentially central position of the pressure-receiving range in a direction that sets the internal combustion engine to a further low compression ratio side.

According to further another preferable configuration, in any of the above-described configurations, the oil passage is located on a vertically upper side with respect to a rotational axis of the control shaft in a state mounted on a vehicle.

According to further another preferable configuration, in any of the above-described configurations, the bearing portion includes two bearing portions in a direction of a rotational axis of the control shaft. The oil passage is opened to each of the two bearing portions.

According to further another preferable configuration, in any of the above-described configurations, the oil passage extends in a direction offset from a radial direction of the bearing portion.

According to further another preferable configuration, in any of the above-described configurations, the oil passage includes a plurality of oil passages in the pressure-receiving range.

According to further another preferable configuration, in any of the above-described configurations, the bearing portion includes a tubular bush between the bearing portion and an outer periphery of the control shaft. The bush includes a groove connecting the oil passage and the pressure-receiving range to each other.

According to further another preferable configuration, in any of the above-described configurations, the groove is located on an outer periphery of the bush.

According to further another preferable configuration, in any of the above-described configurations, the groove is located on an inner periphery of the bush.

Further, from another aspect, a variable compression ratio apparatus for an internal combustion engine, in one configuration thereof, includes a variable compression ratio mechanism for the internal combustion engine, and an actuator. The variable compression ratio mechanism for the internal combustion engine includes a first shaft portion, an eccentric shaft portion integrated with the first shaft portion, and a first link rotatably coupled with an outer periphery of the eccentric shaft portion. The variable compression ratio mechanism for the internal combustion engine can change a piston stroke amount of the internal combustion engine by a rotation of the first shaft portion. The actuator includes an arm link configured to rotate the first shaft portion, a control shaft including the arm link, an electric motor configured to rotate the control shaft, a bearing portion configured to support the control shaft, and a housing including an oil passage opened to a pressure-receiving range over which a contact pressure is received at the bearing portion from the control shaft during an expansion stroke of the internal combustion engine.

Preferably, in the above-described configuration, the control shaft is rotatable in a predetermined angular range smaller than 360 degrees. The pressure-receiving range is a continuous single range including one end-side pressure-receiving range over which the bearing portion receives the contact pressure from the control shaft when a rotational angle of the control shaft is located at one end of the predetermined angular range, and another end-side pressure-receiving range over which the bearing portion receives the contact pressure from the control shaft when the rotational angle of the control shaft is located at another end of the predetermined angular range.

According to another preferable configuration, in any of the above-described configurations, the pressure-receiving range is a range acquired by adding 90 degrees to both ends of a range where a load is input from the driving shaft in the circumferential direction of the bearing portion.

According to further another preferable configuration, in any of the above-described configurations, the pressure-receiving range is a range acquired by adding, to both ends of a range where a load is input from the control shaft in the circumferential direction of the bearing portion, a circumferential width Lc calculated from the following equation,

$$Lc = 2 \times \sqrt{\frac{4}{π} \times \frac{r 1 \times r 2}{r 2 - r 1} \times ( \frac{1 - v {1}^{2}}{E 1} + \frac{1 - v {2}^{2}}{E 2} ) \times \frac{F}{L}} \qquad [ Equation 3 ]$$

in which r1 represents a radius of the control shaft, r2 represents a radius of the bearing, v1 represents a Poisson's ratio of the control shaft, v2 represents a Poisson's ratio of the bearing, E1 represents a Young's modulus of the control shaft, E2 represents a Young's modulus of the bearing, F represents a load input to the control shaft, and L represents a length of the bearing.

The present invention is not limited to the above-described embodiments, and includes various modifications. For example, the above-described embodiments have been described in detail to facilitate better understanding of the present invention, and are not necessarily limited to the configurations including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2017-050716 filed on Mar. 16, 2017. The entire disclosure of Japanese Patent Application No. 2017-050716 filed on Mar. 16, 2017 including the specification, the claims, the drawings, and the abstract is incorporated herein by reference in its entirety.

### REFERENCE SIGN LIST

O rotational axis
R pressure-receiving range
10 control shaft (first shaft portion)
10c eccentric shaft portion
11 second control shaft (control shaft)
12 second control link
13 arm link
20 housing
22 electric motor
202 lubricant oil supply oil passage (oil passage)
203 lubricant oil supply oil passage (oil passage)
204 lubricant oil supply oil passage (oil passage)
301 metallic bush (bearing portion)
301a first bearing hole
301d oil groove
301e oil groove
304 metallic bush
304 second bearing hole
304 metallic bush (bearing portion)
304a second bearing hole

1. An actuator of a variable compression ratio mechanism for an internal combustion engine, the actuator comprising:
an arm link coupled with the variable compression ratio mechanism and configured to change a posture of the variable compression ratio mechanism for the internal combustion engine by swinging;
a control shaft including the arm link;
an electric motor configured to rotate the control shaft; and
a housing including a bearing portion that supports the control shaft, and an oil passage opened to a pressure-receiving range over which a contact pressure is received from the control shaft during an expansion stroke of the internal combustion engine in a circumferential direction of the bearing portion.

2. The actuator of the variable compression ratio mechanism for the internal combustion engine according to claim 1, wherein the control shaft is rotatable in a predetermined angular range smaller than 360 degrees, and
wherein the pressure-receiving range is a continuous single range including
one end-side pressure-receiving range over which the bearing portion receives the contact pressure from the control shaft when a rotational angle of the control shaft is located at one end of the predetermined angular range, and
another end-side pressure-receiving range over which the bearing portion receives the contact pressure from the control shaft when the rotational angle of the control shaft is located at another end of the predetermined angular range.

3. The actuator of the variable compression ratio mechanism for the internal combustion engine according to claim 2, wherein the pressure-receiving range is a range acquired by adding, to both ends of a range where a load is input from the control shaft in the circumferential direction of the bearing portion, a half of a width Lc calculated from the following equation,
$$Lc = 2 \times \sqrt{\frac{4}{π} \times \frac{r 1 \times r 2}{r 2 - r 1} \times ( \frac{1 - v {1}^{2}}{E 1} + \frac{1 - v {2}^{2}}{E 2} ) \times \frac{F}{L}} \qquad [ Equation 4 ]$$
in which
r1 represents a radius of the control shaft,
r2 represents a radius of the bearing,
v1 represents a Poisson's ratio of the control shaft,
v2 represents a Poisson's ratio of the bearing,
E1 represents a Young's modulus of the control shaft,
E2 represents a Young's modulus of the bearing,
F represents a load input to the control shaft, and
L represents a length of the bearing.

4. The actuator of the variable compression ratio mechanism for the internal combustion engine according to claim 2, wherein the pressure-receiving range is a range acquired by adding 90 degrees to both ends of a range where a load is input from the control shaft in the circumferential direction of the bearing portion.

5. The actuator of the variable compression ratio mechanism for the internal combustion engine according to claim 2, wherein the oil passage is opened at a position deviated from a circumferentially central position of the pressure-receiving range in a direction that sets the internal combustion engine to a further low compression ratio side.

6. The actuator of the variable compression ratio mechanism for the internal combustion engine according to claim 2, wherein the oil passage is located on a vertically upper side with respect to a rotational axis of the control shaft in a state mounted on a vehicle.

7. The actuator of the variable compression ratio mechanism for the internal combustion engine according to claim 1, wherein the bearing portion includes two bearing portions in a direction of a rotational axis of the control shaft, and
wherein the oil passage is opened to each of the two bearing portions.

8. The actuator of the variable compression ratio mechanism for the internal combustion engine according to claim 1, wherein the oil passage extends in a direction offset from a radial direction of the bearing portion.

9. The actuator of the variable compression ratio mechanism for the internal combustion engine according to claim 1, wherein the oil passage includes a plurality of oil passages in the pressure-receiving range.

10. The actuator of the variable compression ratio mechanism for the internal combustion engine according to claim 1, wherein the bearing portion includes a tubular bush between the bearing portion and an outer periphery of the control shaft, and
wherein the bush includes a groove connecting the oil passage and the pressure-receiving range to each other.

11. The actuator of the variable compression ratio mechanism for the internal combustion engine according to claim 10, wherein the groove is located on an outer periphery of the bush.

12. The actuator of the variable compression ratio mechanism for the internal combustion engine according to claim 10, wherein the groove is located on an inner periphery of the bush.

13. A variable compression ratio apparatus for an internal combustion engine, comprising:
a variable compression ratio mechanism for the internal combustion engine; and
an actuator,
wherein the variable compression ratio mechanism for the internal combustion engine includes a first shaft portion, an eccentric shaft portion integrated with the first shaft portion, and a first link rotatably coupled with an outer periphery of the eccentric shaft portion,
wherein the variable compression ratio mechanism for the internal combustion engine can change a piston stroke amount of the internal combustion engine by a rotation of the first shaft portion, and
wherein the actuator includes
an arm link configured to rotate the first shaft portion,
a control shaft including the arm link,
an electric motor configured to rotate the control shaft,
a bearing portion configured to support the control shaft, and
a housing including an oil passage opened to a pressure-receiving range over which a contact pressure is received at the bearing portion from the control shaft during an expansion stroke of the internal combustion engine.

14. The variable compression ratio apparatus for the internal combustion engine according to claim 13, wherein the control shaft is rotatable in a predetermined angular range smaller than 360 degrees, and
wherein the pressure-receiving range is a continuous single range including
one end-side pressure-receiving range over which the bearing portion receives the contact pressure from the control shaft when a rotational angle of the control shaft is located at one end of the predetermined angular range, and
another end-side pressure-receiving range over which the bearing portion receives the contact pressure from the control shaft when the rotational angle of the control shaft is located at another end of the predetermined angular range.

15. The variable compression ratio apparatus for the internal combustion engine according to claim 14, wherein the pressure-receiving range is a range acquired by adding 90 degrees to both ends of a range where a load is input from the driving shaft in the circumferential direction of the bearing portion.

16. The variable compression ratio apparatus for the internal combustion engine according to claim 14, wherein the pressure-receiving range is a range acquired by adding, to both ends of a range where a load is input from the control shaft in the circumferential direction of the bearing portion, a circumferential width Lc calculated from the following equation,
$$Lc = 2 \times \sqrt{\frac{4}{π} \times \frac{r 1 \times r 2}{r 2 - r 1} \times ( \frac{1 - v {1}^{2}}{E 1} + \frac{1 - v {2}^{2}}{E 2} ) \times \frac{F}{L}} \qquad [ Equation 5 ]$$
in which
r1 represents a radius of the control shaft,
r2 represents a radius of the bearing,
v1 represents a Poisson's ratio of the control shaft,
v2 represents a Poisson's ratio of the bearing,
E1 represents a Young's modulus of the control shaft,
E2 represents a Young's modulus of the bearing,
F represents a load input to the control shaft, and
L represents a length of the bearing.
